(19) United States
(12) Patent Application Publication
(10) Pub. No.: US 2007/0063603 A1
(43) Pub. Date: Mar. 22, 2007

(54) Integrated motor and controller assemblies for horizontal axis washing machines

(76) Inventors: Gregory M. Levine, St. Louis, MO (US); Daniel E. Hilton, St. Louis, MO (US); Michael W. Major, Moro, IL (US); Stephen J. Burton, Fenton, MO (US); Scott M. Schroer, St. Charles, MO (US); Peter F. Stultz, Elgin, IL (US)

Correspondence Address: HARNESS, DICKEY, & PIERCE, P.L.C, 7700 BONHOMME, STE 400, ST. LOUIS, MO, 63105, US

(21) Appl. No.: 11/601,060

(22) Filed: Nov. 17, 2006

Related U.S. Application Data
(63) Continuation-in-part of application No. 11/208,688, filed on Aug. 22, 2005.

(51) Int. Cl. H02K 3/24; H02K 11/00; H02K 5/10

(52) U.S. Cl. 310/85; 310/64; 310/68 R

(57) ABSTRACT

A front loading washing machine includes an integrated motor and controller assembly. In various embodiment, the controller is mounted directly to one of a pair of opposing endshields of the electric motor and the endshields are mounted directly to a stator of the motor. Additional embodiments include a rotor shaft of the motor having each of opposing ends supported within a bearing mounted within a respective one of the opposing endshields. In other embodiments, the controller can include an insulating shield positioned between a controller circuit board and the motor endshield to which the controller is mounted. The insulating shield providing electrical arcing protection, thermal insulation and/or electromagnetic insulation between the circuit board and the endshield.

### CROSS-REFERENCE TO RELATED APPLICATIONS

This application is a continuation-in-part of U.S. patent application Ser. No. 11/208,688 filed on Aug. 22, 2005.

### FIELD

The present disclosure relates primarily to horizontal axis washing machines, and electric motor and controller assemblies for horizontal axis washing machines.

### BACKGROUND

Many horizontal axis washing machines—also referred to as “front loaders” because laundry is loaded through a door on the front side of the machine—are commonly provided with a variable speed electric motor for driving rotation of a laundry tub. The electric motor is typically located adjacent the tub and mechanically coupled to the tub using a belt system. A controller for the electric motor is mounted away from the electric motor, often adjacent to a controller for the washing machine, and electrically coupled to the electric motor via a cable assembly. While the motor shaft is generally horizontal, e.g., typically between 0° and 20°, those skilled in the art will readily recognize that the laundry tub axis of such front loaders can vary from approximately 0° to approximately 45° with respect to the horizontal.

As recognized by the present inventors, these known front loading washing machines have several disadvantages. For example, locating the motor controller away from the motor requires use of the cable assembly, which typically includes interference retarding components to reduce television interference. Additionally, because the motor controllers commonly include heat sinks mounted within a controller housing—also referred to as a drip shield—the controller housing is unnecessarily large, resulting in increased materials cost, and restricts heat dissipation from the heat sink.

### SUMMARY

To solve these and other needs, the present inventors have succeeded at designing, among other things, an integrated motor and controller assembly for horizontal axis washing machines, i.e., front loading washing machine.

According to various embodiments of the present disclosure, an electric motor and controller assembly for a horizontal axis washing machine includes an electric motor and a controller. The controller is mounted to an endshield of the electric motor. The controller includes a circuit board and an insulating shield positioned between the circuit board and the motor endshield.

According to various other embodiments of the present disclosure, an electric motor and controller assembly for a horizontal axis washing machine includes an electric motor and a controller. The controller includes software for controlling operation of the electric motor in the horizontal axis washing machine, and is mounted directly to an endshield of the electric motor. The endshield is mounted directly to a stator of the motor.

According to still other various embodiments of the present disclosure, an electric motor and controller assembly for a horizontal axis washing machine includes an electric motor and a controller. The controller is mounted to one of a pair of opposing motor endshields. Each endshield supports a bearing and each bearing supports an opposing end of a shaft of the motor.

According to yet other various embodiments of the present disclosure, a horizontal axis washing machine includes a tub, an electric motor, and a motor controller for the electric motor. The motor controller is mounted directly to one of a pair of opposing endshields that are mounted directly to a stator of the motor. Each endshield is structured to support a bearing. The bearings support opposing ends of a shaft of the motor and provide vibration damping during operation of the motor. The controller includes a circuit board and an insulating shield positioned between the circuit board and the motor endshield to which the controller is directly mounted.

Further embodiments of the present disclosure will be in part apparent and in part pointed out below. It should be understood that the various embodiments may be implemented individually or in combination with one another. It should also be understood that the detailed description and drawings, while indicating certain exemplary embodiments, are intended for purposes of illustration only and should not be construed as limiting the scope of the present disclosure.

### BRIEF DESCRIPTION OF THE DRAWINGS

FIG. 1 is a perspective view of an electric motor and controller assembly according to various embodiments of the present disclosure.

FIG. 2 is a block diagram of a horizontal axis washing machine incorporating the electric motor and controller shown in FIG. 1, in accordance with various embodiments of the present disclosure.

FIG. 3 is an exploded perspective view of the electric motor and controller assembly shown in FIG. 1, in accordance with various embodiments of the present disclosure.

FIG. 4 is a top plan view of the stator of FIG. 3 illustrating a direct connection of magnet wires to a connector for the motor controller, in accordance with various embodiments of the present disclosure.

FIG. 5 is a perspective view of an electric motor and controller including a modular controller and an open motor shell feature, in accordance with additional embodiments of the present disclosure.

FIG. 6 is an exploded perspective view of the electric motor and controller assembly shown in FIG. 5, in accordance with various other embodiments of the present disclosure.

Like reference symbols indicate like elements or features throughout the drawings.

### DETAILED DESCRIPTION OF EXEMPLARY EMBODIMENTS

Illustrative embodiments of the present disclosure are described below. In the interest of clarity, not all features of an actual implementation are described in this specification. It will be appreciated that in the development of any actual embodiment, numerous implementation-specific decisions must be made to achieve specific goals, such as performance objectives and compliance with system-related, business-related and/or environmental constraints. Moreover, it will be appreciated that such development efforts may be complex and time-consuming, but would nevertheless be a routine undertaking for those of ordinary skill in the art having the benefit of this disclosure.

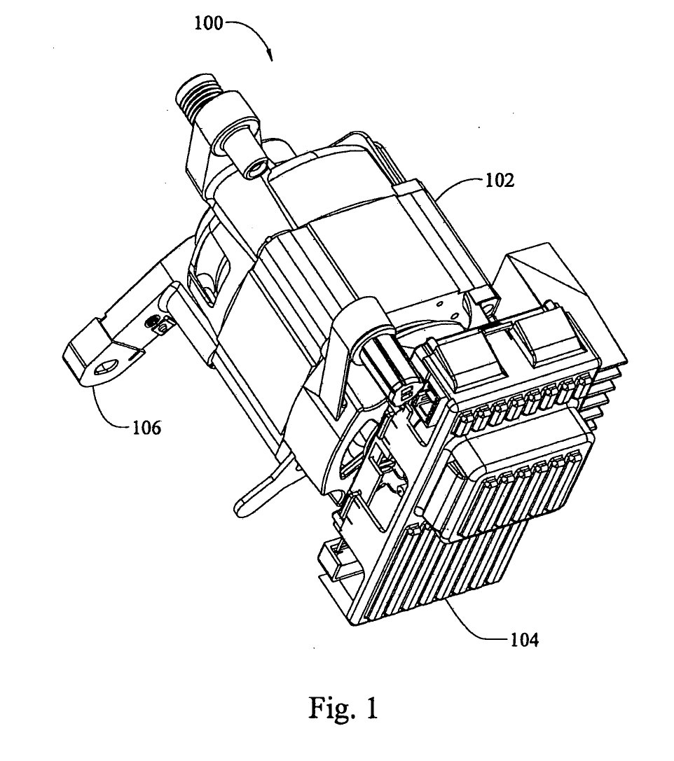

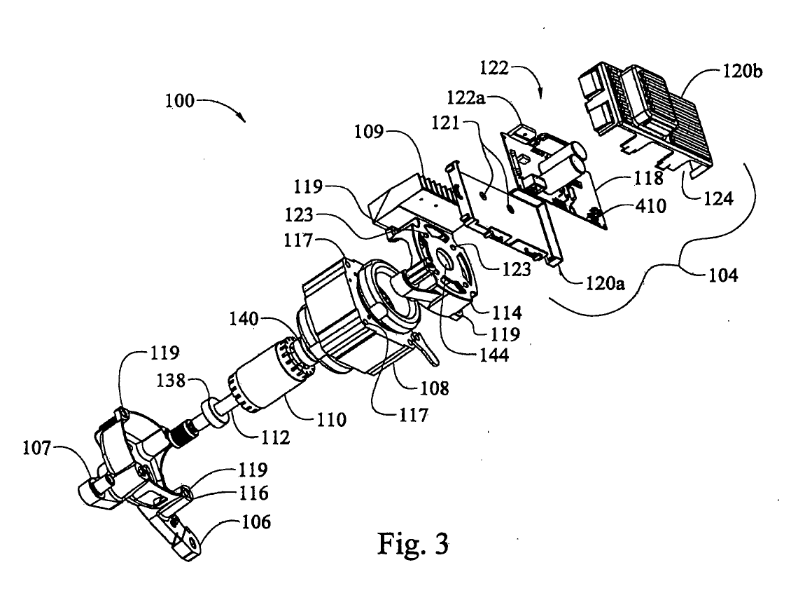

An exemplary motor and controller assembly for a horizontal axis washing machine, i.e., front loader washing machine, according to various embodiments of the present disclosure is illustrated in FIG. 1 and indicated generally by reference number 100. As shown in FIG. 1, the assembly 100 includes an electric motor 102 and a controller 104. The controller 104 includes, among other things, software for controlling operation of the electric motor 102 in a horizontal axis washing machine, typically in response to commands from a machine controller for the washing machine. Additionally, the electric motor 102 includes at least one attachment point 106 for mounting the electric motor 102 in a horizontal axis washing machine. An additional attachment point 107 is shown in FIG. 3, described below.

In various embodiments, the electric motor 102 is a variable speed controlled induction motor. It should be understood, however, that other motor types, including brushless permanent magnet (BPM) and switched reluctance (SR) motors, can be employed without departing from the scope of the present disclosure. Furthermore, while the embodiment of FIG. 1 contemplates distinct machine and motor controllers, the machine controller can be integrated into the motor controller mounted to the electric motor without departing from the scope of the present disclosure.

In contrast to known washing machines having a motor controller positioned remotely from an electric motor, the controller 104 of FIG. 1 is mounted to the electric motor 102. Further, as described below, in various embodiments the controller 104 is mounted to an endshield of the motor that is mounted to a stator of the motor. As a result, various components employed in known designs are preferably eliminated in many embodiments of the disclosure, including wiring harnesses commonly provided between motors and controllers, EMI retarding components commonly included in the wiring harnesses, connectors, etc. Mounting the controller on the motor contributes to a more compact design, simplifies manufacturing, and reduces production costs for the assembly 100 and any front loader washing machine that incorporates the assembly 100.

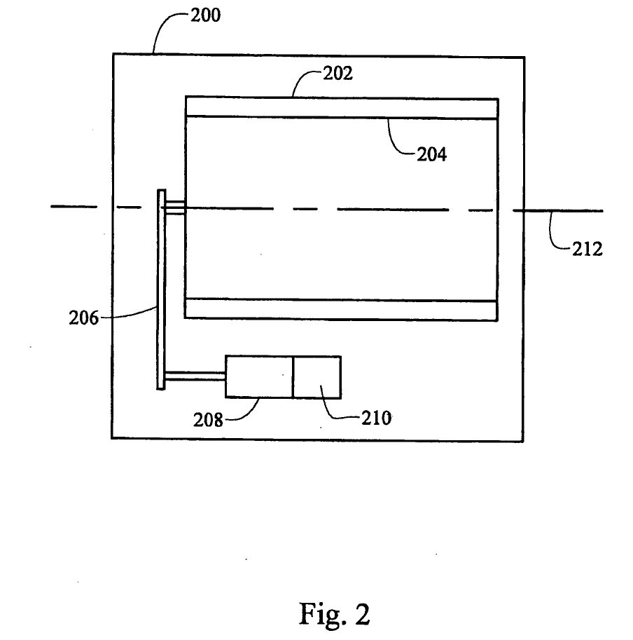

FIG. 2 illustrates a horizontal axis washing machine 200 according to various embodiments. As shown in FIG. 2, the washing machine 200 includes an outer tub 202, an inner tub 204, an electric motor 208 and a controller 210 for the electric motor 208. The controller 210 is mounted to the electric motor 208. Further, at least a portion of the controller 210 is positioned under the outer tub 202. As a result, the outer tub 202 provides drip protection for the controller 210 including, for example, when the inner tub 204 overflows with water. Further, in cases where the controller 210 includes a housing (also referred to as a drip shield) for providing drip protection, the dimensions of the housing can be reduced, resulting in material savings, due to the drip protection provided by the tub 204. Additionally, positioning the motor 208 and the controller 210 under the outer tub 202 can help move air across any heat sink positioned on the motor 208 or the controller 210. This is particularly true where the outer tub 202 is suspended within the washing machine 200 for limited movement or vibration of the outer tub 202 during operation of the machine 200.

Although FIG. 2 illustrates a motor shaft of the motor 208 as being generally horizontal, in various embodiments, the electric motor 102 can be mounted within the washing machine 200 such that the motor shaft is oriented at between approximately 0° and 20° with respect to a bottom plane of the washing machine. As shown in FIG. 2, the motor 208 is coupled to the inner tub 204 via a belt 206 for driving rotation of the inner tub 204. FIG. 2 also illustrates a generally horizontal center axis 212 of the inner tub 204. However, as will be readily appreciated by one skilled in the art, the center axis 212 of front loader washing machines, such as washing machine 200, can vary from between approximately 0° to 45° with respect to a bottom plane of the washing machine.

One example of a suitable motor and controller assembly for use in the horizontal axis washing machine 200 of FIG. 2 is the motor and controller assembly 100 shown in FIG. 1. The assembly 100 will now be further described with reference to the exploded view of FIG. 3.

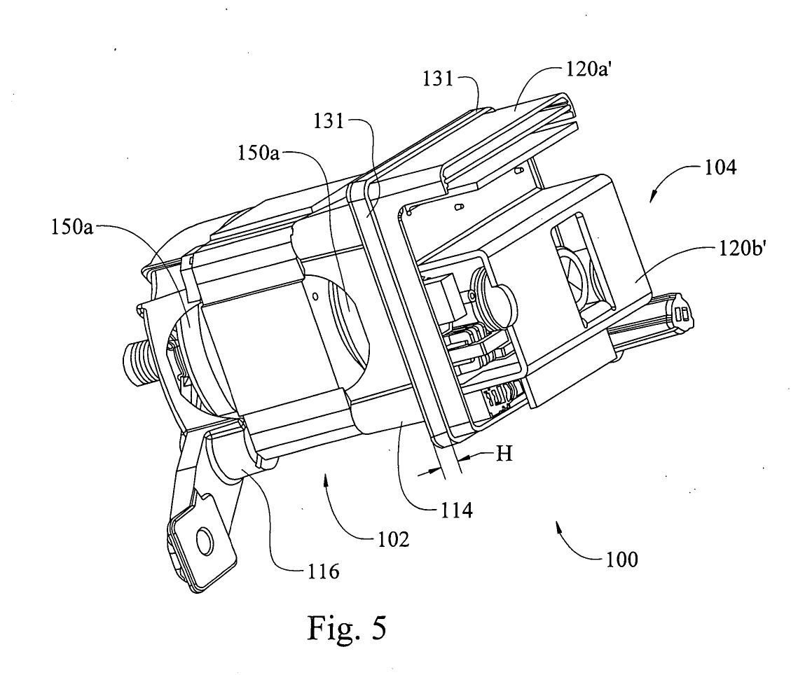

As shown in FIG. 3, the electric motor 102 of FIG. 1 includes a stator 108, a rotor 110 situated for rotation relative to the stator 108, a shaft 112 and endshields 114, 116. In various implementations, as exemplarily illustrated in FIG. 3, the rotor 110 is designed to rotate within an inner bore of the stator 108, referred to herein as an outer stator design. Alternatively, outer rotor designs can be employed without departing from the scope of the disclosure. Additionally, with reference to FIGS. 3 and 5, in accordance with various embodiments, the controller 104 is mounted directly to the endshield 114 and the endshield 114 is mounted directly to the stator 108.

The endshield 114 can be mounted to the stator 108 using any suitable fastening means. For example, the stator 108 can include bores 117 through which threaded rods (not shown) are inserted. The threaded rods can extend beyond the ends of the stator 108 and through mounting apertures 119 in both endshields 114 and 116. Threaded fasteners, e.g., nuts, (not shown) can then be threaded on opposing ends of the threaded rod to couple both endshields 114 and 116 directly to the stator 108. The controller 104 can then be mounted directly to the endshield 114 using any suitable coupling means. For example, as illustrated in FIG. 3, the controller 104 can be mounted directly to the endshield 114 using screws (not shown) that extend through apertures 121 of a controller housing base 120a and thread into threaded apertures 123 of the endshield 114. Similarly, the modular controller subassembly 104 of FIG. 5 can be directly coupled to the endshield 114 via screws (not shown) that are inserted through apertures 126 in both the controller base 120a and a controller housing cover 120b and threaded into threaded apertures 128 of the endshield 114.

Alternatively, the controller 104 can be directly coupled to the endshield 114 using any other suitable coupling means or fasteners such as nuts and bolts, snap fasteners, rivets, etc. Still further, in various embodiments, the controller housing base 120a can be integrally formed with the endshield 114 to directly couple the controller 104 to the endshield 114.

With reference again to FIG. 3, the controller 104 includes a circuit board 118, a housing 120, and various circuit components 122 (including at least one heat producing component 122a) attached to the circuit board 118 and generally protected by the housing 120. The housing 120 includes the base, or circuit board tray, 120a and the cover 120b that can be removably attached to the base 120a. The base 120a is structured to receive and have mounted thereto the circuit board 118. The base 120a is further structured to be coupled to the endshield 114 to thereby mount the controller 104 to the motor 102. The base 120a and cover 120b can be fabricated of plastic or other electrically insulating materials. Additionally, as described below, in various embodiments the base 120a can provide electrical, thermal, and/or electromagnetic interference protection between the motor 108 and the controller 104.

As exemplarily illustrated in FIG. 3, a heat sink 109 is positioned on the endshield 114. The heat sink 109 can be integrally attached to the endshield 114. In various implementations the heat sink 109 and the endshield 114 can have a monolithic (i.e., single unit) construction and be formed from cast grade aluminum. This results in material savings as compared to prior art designs employing separate endshields and heat sinks. Alternatively, the heat sink 109 and the endshield 114 can be formed separately, in which case the heat sink 109 can optionally be positioned at a different location on the motor and controller assembly 100.

The heat sink 109 is provided for dissipating heat generated by the heat producing component 122a (and possibly other components 122). In various exemplary constructions, the heat producing component 122a is thermally coupled to the heat sink 109 after the circuit board 118 is attached to the housing base 120a. The housing cover 120b is then attached to the housing base 120a to protect the circuit board 118 and its various components 122. Alternatively, as described above, in various embodiments, the controller 104 is a modular subassembly that is assembled separately from the motor 102 and then subsequently coupled to the motor endshield 114. Thus, the base 120a, the circuit board 118 and the cover 120b can be assembled to form the controller 104 that is then coupled to the endshield 114. The heat sink 109 can then be thermally coupled to the heat producing component 122a subsequent to mounting the controller 104 to the motor 102.

The heat producing component 122a can be thermally coupled to the heat sink 109 in any suitable manner. For example, the component 122a can be physically attached to the heat sink 109 using fasteners and/or adhesives. Additionally, thermal paper may be provided between the heat producing component 122a and the heat sink 109 to enhance the transfer of heat therebetween. As shown in FIG. 3, in various embodiments the housing cover 120b includes an opening 124 through which the heat producing component 122a is thermally coupled to the heat sink 109. Although only one opening 124 is shown in FIG. 3, additional openings in the cover 120b can be provided as necessary for any particular application.

It should be noted that, in the embodiment of FIG. 3, the heat sink 109 is positioned on the motor 102 external to the controller housing 120. This is in contrast to prior art designs having a heat sink positioned within an interior of the controller housing 120. By positioning the heat sink 109 external to the controller housing 120, the dimensions of the housing can be reduced, resulting in material savings. Additionally, positioning the heat sink 109 external to the controller housing 120 allows for greater air flow across the heat sink and, therefore, increases the heat dissipating ability of the heat sink 109. This is particularly the case when the heat sink 109 is positioned below the tub of a horizontal axis washing machine where movement or vibration of the tub during operation will produce air movement across the heat sink 109.

Although the heat sink 109 positioned on the motor 102 and external to the controller housing 120 has been described above in connection with the motor and controller assembly 100 for a horizontal axis washing machine, it should be understood that these heat sink features can be applied to other electric motor designs and applications without departing from the scope of the present disclosure.

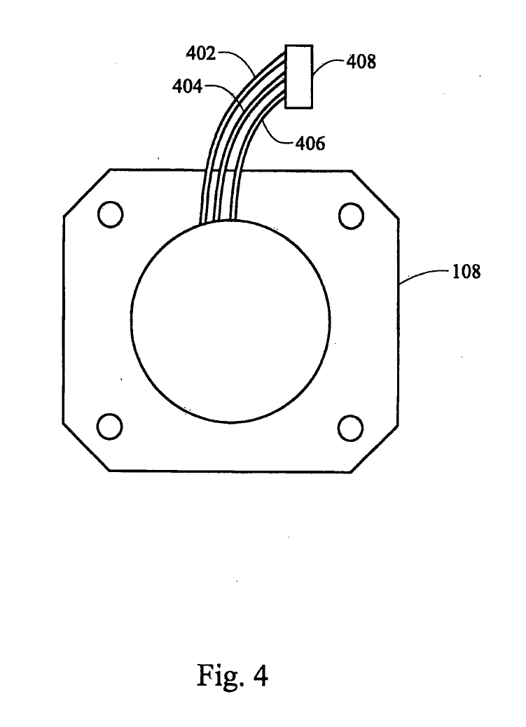

FIG. 4 illustrates additional features of the stator 108 shown in FIG. 3. As shown in FIG. 4, the stator 108 includes three magnet wires 402, 404, 406 (i.e., typically copper wire wound around portions of the stator to form magnetic coils) coupled directly to a connector 408. The connector 408 mates with a connector 410 on the controller circuit board 118, shown in FIG. 3. In this manner, the magnet wires 402, 404, 406 are connected with the controller 104 using a single set of connectors 408, 410. This is in contrast to prior art designs which splice magnet wires to lead wires, connect the lead wires to a plug on the motor, and connect the plug on the motor to a plug on the motor controller via a wiring harness. By connecting the magnet wires 402, 404, 406 to the controller 104 via a single set of connectors 408, 410, reliability of the motor and controller assembly 100 can be improved while simplifying its assembly and reducing costs. In the particular embodiment illustrated in FIGS. 3 and 4, the connectors 408, 410 are IDC connectors. Furthermore, portions of the magnet wires 402-406 extending from the stator 108 to the connector 408 can be covered with insulative sleeving (not shown). While described in connection with the assembly 100 of FIGS. 1 and 3, it should be understood that the direct connection of the stator magnet wires 402, 404, 406 to a controller can be employed in other motor applications without departing from the scope of the present disclosure.

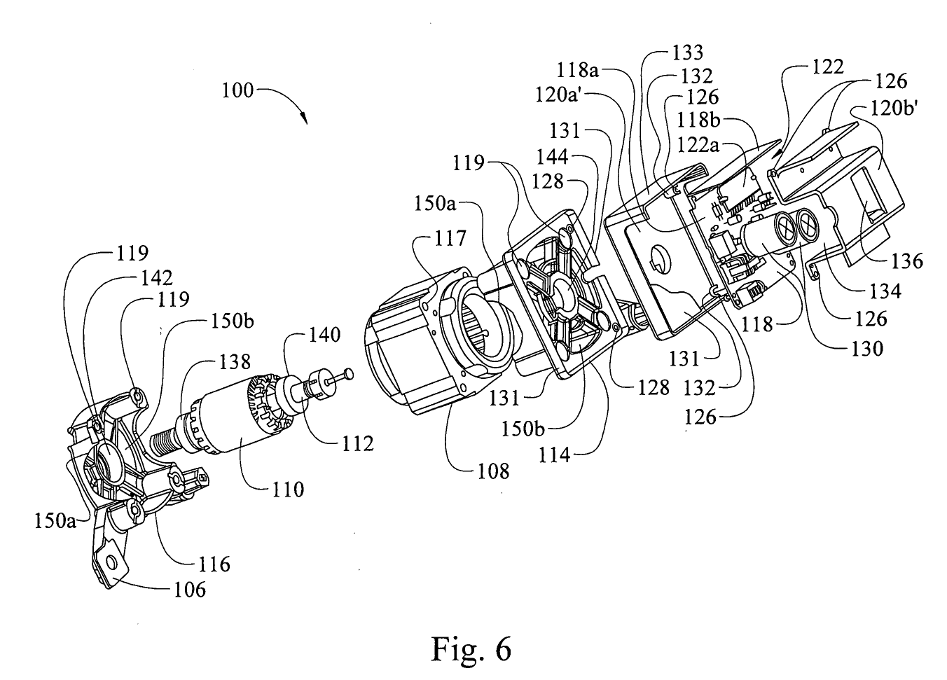

FIGS. 5 and 6 illustrate the electric motor and controller assembly 100, in accordance with various additional embodiments of the present disclosure. In various embodiments, the controller 104 is a modular subassembly that is preassembled and then coupled to the stator endshield 114 such that the modular controller subassembly 104 is integrally coupled with the endshield 114. Additionally, the base 120a of the modular controller 104 is an insulating shield, referred to herein as insulating shield 120a′ and the cover 120b is a heat sink, referred to herein as heat sink 120b′.

The insulating shield 120a′ can provide one or more of various types of insulation between the circuit board 118 and the endshield 114. For example, the insulating shield 120a′ can be an electrical insulator to prevent arcing between the circuit board 118 and endshield 114. Generally, the controller 104, i.e., the circuit board 118, operates to control the application of voltages to the motor 102. Accordingly, various components of the circuit board 118 have high operating voltage, e.g., 120 volts, such as high voltage component 130. Additionally, the motor 102, i.e., the endshield 114, is generally grounded at a ground reference potential. Thus, arcing could occur between the high voltage components, e.g., high voltage component 130, on the circuit board 118 and the endshield 114. The insulating shield 120a′ provides electrical insulation to prevent such arcing. To provide such electrical insulation, the insulating shield 120a′ can be fabricated from any suitable electrical dielectric, or electrically insulative, material such as various plastics, resins, fiber filled polymer, fiberglass, etc.

The insulating shield 120a′ can also be a thermal insulator to prevent undesirable exchange of heat between the circuit board 118 and the endshield 114. For example, transfer of heat generated by the motor 102 during operation to the circuit board 118 can damage or undesirably affect functionality of the electronics, e.g., high temperature component 122a and high voltage component 130, of the circuit board 118. To provide the thermal insulation the insulating shield 120a′ can be fabricated from any suitable thermally insulative material such as various plastics, resins, fiber filled polymer, fiberglass, etc.

Still further, the insulating shield 120a′ can be an electro-magnetic interference (EMI) insulator that shields the circuit board 118 from adverse affects of electromagnetic fields created by the motor 102 during operation, and vice-versa. To provide the EMI insulation described above the insulating shield 120a′ can be fabricated from any suitable EMI insulative material such as various plastics, resins, fiber filled polymer, fiberglass, etc. Thus, the insulating shield 120a′ can provide electrical insulation, thermal insulation, EMI insulation or any combination thereof.

To provide additional electrical, thermal and/or EMI insulation between the circuit board 118 and the endshield 114, in various other embodiments, the insulating shield 120a′ can include a insulative layer 131 comprising an insulative fabric, potting compound, conformal coating or any other suitable insulating coating. The insulative layer 131, i.e., insulative fabric, potting compound, conformal coating, etc., is fabricated from any suitable electrically, thermally and/or EMI insulative material such as various plastics, resins, fiber filled polymer, fiberglass, etc. Furthermore, to provide additional electrical, thermal and/or EMI insulation between the circuit board 118 and the endshield 114, in various other embodiments, the insulating shield 120a′ can include stand-off bosses 132. The stand-off bosses 132 provide additional physical separation between the circuit board 118 and the motor and endshield 102 and 114. The height of the stand-off bosses 132, e.g., distance of physical separation, can be any height suitable to provide a desired amount of electrical, thermal and/or EMI insulation.

As exemplarily illustrated in FIG. 6, the heat sink 120b′ is formed to fit over the circuit board 118 and the electronic components thereon to cover and generally protect the circuit board 118 when the modular controller 104 is assembled. The heat sink 120b′ can be fabricated for any suitable thermally conductive material. For example, the heat sink 120b′ can be a bent, pressed or formed aluminum extrusion. Alternatively, in various embodiments, the heat sink 120b′ can be constructed of a metal, e.g., aluminum, fabricated to have an enhanced level of thermal conductivity to more quickly and efficiently dissipate heat from the circuit board 118. The heat sink 120b′ is provided for dissipating heat generated by the heat producing component 122a (and possibly other components 122).

In various exemplary constructions, the circuit board 118 is coupled directly with the heat sink 120b′ so that the heat producing component 122a is thermally coupled to the heat sink 120b′. The circuit board 118 can be coupled to the heat sink 120a′ using snaps, screws, rivets, glue or any other suitable fastening means. The heat sink 120b′ and circuit board 118 assembly is then coupled to the insulating shield 120a′ to form the modular controller 104. The heat sink 120b′ and circuit board 118 assembly can be coupled to the insulating shield using any suitable fastening means, such as snap connectors, screws, rivets, glue, etc. The assembled modular controller 104 is then directly coupled to the endshield 114 such that the modular controller 104 is integrally coupled to the endshield 104.

The heat producing component 122a can be thermally coupled to the heat sink 120b′ in any suitable manner. For example, physical contact can be made between the component 122a and the heat sink 120b′ when the heat sink 120b′ is coupled with circuit board 118. Additionally, thermal paper may be provided between the heat producing component 122a and the heat sink 109 to enhance the transfer of heat therebetween. Furthermore, in various implementations, the heat sink 120b′ can include open sides 134 and/or one or more windows 136 to provide an ‘open’ construction of the modular controller 104. The ‘open’ construction allows air to flow through the controller 104 to provide additional cooling to the circuit board components 122 and 130.

In various embodiments, after the circuit board 118 is coupled to the heat sink 120b′, screws (not shown) are inserted through the apertures 126 in the heat sink 120b′ and the insulative shield 120a′. The screws are then threaded into the threaded apertures 128 of the endshield 114 to integrally mount the modular controller 104 to the endshield 114. By integrally mounting the modular controller 104 to the endshield 114, any force or stress that is exerted on the modular controller 104 will be transferred directly to the endshield 114 and not imparted on the circuit board 118 within the modular controller 104. For example, forces or stresses from handling the motor and controller assembly 100 using the modular controller as a handle will be distributed, via the screws connecting the modular controller 104 to the endshield 114, directly to the endshield 114. Accordingly, such forces and stresses will not be applied to the circuit board 118, thereby preventing the circuit board 118 from damage resulting from movement, flexing, vibration, etc. of circuit board 118.

In some implementations, one of the screws used to integrally couple the modular controller 104 to the endshield 114, as described above, is utilized to electrically ground the circuit board 118 to the endshield 114.

To provide additional protection against damage to the circuit board 118, due to forces or stresses applied to the modular controller 104, in some embodiments, the endshield 114 is fabricated to include a controller receiving wall 131. The controller receiving wall extends substantially orthogonally from the controller-end of the endshield 114, e.g., from the perimeter of the controller-end, and forms a reservoir in which the modular controller 104 is seated when integrally coupled to the endshield 114. More specifically, the perimeter shape and dimensions of the controller receiving wall 131 are such that the insulating shield 120a′ fits snuggly within the controller receiving wall 131 when the modular controller 104 is integrally coupled to the endshield 114.

The controller receiving wall 131 has a height H that extends along the sides of the insulating shield 120a′, thereby adding support to the sides of the modular controller 104. Accordingly, the controller receiving wall 131 will provide added support to the modular controller to displace forces and stresses to the endshield 114. Additionally, controller receiving wall 131 provides sufficient surface area that the motor and controller assembly 100 can be handled by directly grasping the controller receiving wall 131. Thus, no force or stress would be applied to the modular controller 104 during such handling of the motor and controller assembly 100. The height H of the controller receiving wall 131 can be any suitable height, for example, in various embodiments, the height H is approximately ¼ of an inch, ½ of an inch, ¾ of an inch, etc.

Referring particularly to FIG. 6, in various embodiments, the circuit board 118 is a fabricated as two portion circuit board including a first portion 118a and a second portion 118b. In some forms, the first and second circuit board portions 118a and 118b are separate, independent portions that are effectively orthogonally connected to each other. Alternatively, the circuit board 118, more particularly the substrate of the circuit board 118, can be bent at approximately 90° to form the first and second portions 118a and 118b. Fabricating the circuit board 118 to have a two portions orthogonally oriented with each other reduces the over all dimensions, i.e., foot print, of the circuit board 118. Reducing the footprint of the circuit board 118 allows the size of the other components of the modular controller 104, i.e., the insulative shield 120a′ and the heat sink 120b′ to be reduces, thereby providing material cost savings and reduces the overall size of the motor and controller assembly 100. Reducing the overall size of the modular controller 104 can significantly reduce or eliminate any portion of the modular controller 104 that might extend radially beyond the perimeter of the endshield 114. This can reduce the risk of physical impact damage, force and/or stress being imparted on the modular controller 104.

In such embodiments, the insulative shield can include a hood portion 133. The hood 133 substantially covers and provides physical protection and insulative protection, e.g., electrical, thermal and/or EMI insulation, for the circuit board second portion 118b.

Referring now to FIGS. 3 and 6, in accordance with various embodiments, the motor 102 includes first bearing 138 and a second bearing 140 press fitted on opposing ends of the motor shaft 112 at opposite ends of the rotor 110. When the motor 102 is assembled, the first bearing 138 has a friction fit within a first bearing recess 142 in the endshield 116 (best shown in FIG. 6), and the second bearing 140 has a friction fit within a second bearing recess 144 in the endshield 116. Thus, when the motor 102 is assembled, the rotor 110 and shaft 112 are supported at opposing ends of the rotor 110 and shaft 112. Therefore, the rotor 110 is precisely positioned and well supported on both sides of the motor for rotation within the stator 108. Additionally, having the rotor 110 and shaft 112 supported at opposing ends by first and second bearing 138 and 140 provides enhanced vibration damping as compared to known cantilevered shaft motors.

Referring again to FIGS. 5 and 6, in various embodiments the motor 102 has an ‘open shell’ construction to allow cooling air to flow though the motor 102. More particularly, the endshields 114 and 116 are formed to include a plurality of heating venting passages 150. The heat venting passages 150 include at least one window 150a formed in a side of the respective endshield 114 and 116 and/or at least one opening 150b formed in a bottom of the respective endshield 114 and 116. The heat venting passages 150 allow the passage of air through, over and around the interior of the motor 102. Accordingly, air can flow through the heat venting passages 150 to absorb and remove heat generated during operation of the motor 102, thereby enhancing the efficiency and life of the motor 102.

Additionally, those skilled in the art will recognize that various changes can be made to the exemplary embodiments and implementations described above without departing from the scope of the present disclosure. Accordingly, all matter contained in the above description or shown in the accompanying drawings should be interpreted as illustrative and not in a limiting sense.

What is claimed is:

1. An electric motor and controller assembly for a horizontal axis washing machine, the assembly comprising an electric motor and a controller mounted to an endshield of the motor, the controller including a circuit board and software for controlling operation of the electric motor in the horizontal axis washing machine, and an insulating shield positioned between the controller circuit board and the motor endshield.

2. The assembly of claim 1, wherein the insulating shield comprises an electrical arcing insulating shield.

3. The assembly of claim 1, wherein the insulating shield comprises a thermal insulating shield.

4. The assembly of claim 1, wherein the insulating shield comprises an electromagnetic interference insulating shield.

5. The assembly of claim 1, wherein the insulating shield includes an insulative layer comprising potting compound.

6. The assembly of claim 1, wherein the insulating shield includes an insulative layer comprising one of an insulative fabric and a conformal coating.

7. The assembly of claim 1, wherein the insulating shield comprises a plurality of stand-off bosses to provide a pre-determined amount of physical separation between controller circuit board and the motor endshield to which the controller is mounted.

8. The assembly of claim 1, wherein the motor comprises a stator to which the endshield is directly mounted and the controller is mounted directly to the endshield.

9. The assembly of claim 1, wherein the motor includes a pair of endshields mounted to opposing ends of the stator, each endshield supporting a bearing, each bearing supporting an opposing end of a rotor shaft.

10. The assembly of claim 1, wherein the endshield is structured to include at least one heat venting passage to provide heat dissipation during operation of the motor.

11. The assembly of claim 1, wherein the assembly comprises:
a pair of opposing endshields, at least one of the endshields mounted directly to a stator of the motor and having the motor controller mounted directly thereto, each endshield structured to include at least one heat venting passage to provide heat dissipation during operation of the motor; and
a rotor mounted on a rotor shaft having each of opposing ends supported within a bearing mounted within a respective one of the opposing endshields for allowing rotation of the stator within an interior space of the stator; and wherein the controller insulating shield is positioned between the controller circuit board and the motor endshield to which the controller is mounted.

12. The assembly of claim 1, wherein the endshield comprises a controller receiving wall extending from the endshield, the controller receiving wall forming a reservoir into which the controller is seated.

13. The assembly of claim 1, wherein the circuit board comprises a first portion substantially orthogonally oriented with a second portion of the circuit board.

14. The assembly of claim 13, wherein the insulating shield includes a hood portion substantially covering the second portion of the circuit board.

15. The assembly of claim 1, wherein the controller is a modular controller subassembly integrally mounted to the endshield such that forces applied to the modular controller subassembly are transferred directly to the endshield.

16. The assembly of claim 15, wherein the modular controller subassembly is integrally mounted to the endshield utilizing a plurality of screws, at least one of which electrically grounds the circuit board to the endshield.

17. An electric motor and controller assembly for a horizontal axis washing machine, the assembly comprising an electric motor and a modular controller subassembly including a circuit board and software for controlling operation of the electric motor in the horizontal axis washing machine, the modular controller subassembly integrally mounted to an endshield of the electric motor and the endshield mounted directly to a stator of the motor.

18. The assembly of claim 17, wherein the modular controller subassembly is mounted directly to the endshield such that forces applied to the modular controller subassembly are transferred directly to the endshield.

19. The assembly of claim 17, wherein the modular controller subassembly comprises a heat sink formed and utilized as a portion of a housing of the modular controller subassembly.

20. The assembly of claim 17, wherein the modular controller subassembly comprises an insulating shield formed and utilized as a portion of a housing of the modular controller subassembly, the insulation shield comprising at least one of an electrical arcing insulating shield, a thermal insulating shield, and an electromagnetic interference insulating shield positioned between the controller circuit board and the motor endshield to which the controller is mounted.

21. The assembly of claim 17, wherein the motor includes a pair of endshields mounted to opposing ends of the stator, each endshield supporting a bearing, each bearing supporting an opposing end of a rotor shaft.

22. The assembly of claim 17, wherein the endshield is structured to include at least one heat venting passage to provide heat dissipation during operation of the motor.

23. The assembly of claim 17, wherein the endshield comprises a controller receiving wall extending from the endshield, the controller receiving wall forming a reservoir into which the modular controller subassembly is seated.

24. An electric motor and controller assembly for a horizontal axis washing machine, the assembly comprising an electric motor and a modular controller subassembly integrally mounted to one of a pair of opposing endshields of the motor, each endshield supporting a bearing, each bearing supporting an opposing end of a rotor shaft.

25. The assembly of claim 24, wherein the motor comprises a stator to which each of the endshields is directly mounted and the modular controller subassembly is mounted directly to one of the endshields.

26. The assembly of claim 24, wherein the modular controller subassembly comprises a circuit board, a heat sink formed and utilized as a portion of a housing of the modular controller subassembly, and an insulating shield formed and utilized as a portion of the housing of the modular controller subassembly, the insulating shield comprising and at least one of an electrical arcing insulating shield, a thermal insulating shield, and an electromagnetic interference insulating shield positioned between the controller circuit board and the motor endshield to which the controller is mounted.

27. The assembly of claim 24, wherein each endshield is structured to include at least one heat venting passage to provide heat dissipation during operation of the motor.

28. The assembly of claim 24, wherein the endshield to which the modular controller subassembly is integrally mounted includes a controller receiving wall extending from the endshield, the controller receiving wall forming a reservoir into which the modular controller subassembly is mounted.

29. A horizontal axis washing machine, said horizontal washing maching comprising:
a tub;
an electric motor including:
a pair of opposing endshields mounted directly to a stator of the motor; and
a rotor mounted on a rotor shaft having each of opposing ends supported within a bearing mounted within a respective one of the opposing endshields for allowing rotation of the stator within an interior space of the stator; and
a motor controller mounted directly to one of the opposing motor endshields, the controller including:
a circuit board and software for controlling operation of the electric motor in the horizontal axis washing machine; and
an insulating shield positioned between the circuit board and the motor endshield to which the controller is mounted.

30. The horizontal axis washing machine of claim 29, wherein each endshield is structured to include at least one heat venting passage to provide heat dissipation during operation of the motor.

31. The horizontal axis washing machine of claim 29, wherein the controller is a modular subassembly comprising the circuit board, the insulating shield formed and utilized as a portion of a housing of the modular controller subassembly and a heat sink formed and utilized as a portion of the modular controller subassembly housing.

32. The horizontal axis washing machine of claim 29, wherein the controller is directly mounted to the endshield utilizing a plurality of screws, at least one of which electrically grounds the circuit board to the endshield.

33. The horizontal axis washing machine of claim 29, wherein the insulating shield comprises at least one of an electrical arcing insulating shield, a thermal insulating shield, and an electromagnetic interference insulating shield.

34. The horizontal axis washing machine of claim 29, wherein the endshield to which the controller is mounted includes a controller receiving wall extending from the endshield, the controller receiving wall forming a reservoir into which the controller is mounted.

35. The horizontal axis washing machine of claim 29, wherein the insulating shield includes an insulative layer comprising at least one of a layer of potting compound, a layer of conformal coating and a layer of insulative fabric.

36. The horizontal axis washing machine of claim 29, wherein the insulating shield comprises a plurality of stand-off bosses to provide a pre-determined amount of physical separation between controller circuit board and the motor endshield to which the controller is mounted.
